(19) United States
(12) Patent Application Publication
(10) Pub. No.: US 2019/0006811 A1
(43) Pub. Date: Jan. 3, 2019

(54) LASER DEVICE WITH AN OPTICAL RESONATOR AND METHOD FOR ADJUSTING THE LASER DEVICE

(71) Applicant: ROFIN SINAR LASER GMBH, Hamburg (DE)

(72) Inventors: Sina SCHOLZ-RIECKE, München (DE); Nicolas KUGLER, Röhrmoos (DE)

(21) Appl. No.: 16/062,050

(22) PCT Filed: Jul. 12, 2016
(86) PCT No.: PCT/EP2016/080151

§ 371 Date: Jun. 13, 2018

(30) Foreign Application Priority Data
Dec. 18, 2015 (DE) 10 2015 122 249.3
Apr. 12, 2016 (DE) 10 2016 106 742.3

(51) Int. Cl. H01S 3/06; H01S 3/08; H01S 3/081; H01S 3/102; H01S 3/086; H01S 3/113

(52) U.S. Cl. CPC H01S 3/0615; H01S 3/0617; H01S 3/08022; H01S 3/08059; H01S 3/113; H01S 3/1022; H01S 3/0627; H01S 3/086; H01S 3/0813

(57) ABSTRACT

The invention relates to an optical resonator (1) for a laser device (20), in particular for a microchip solid-state laser, comprising an optical medium (4) which is arranged between a first and a second reflective element (2, 3) that are arranged at a distance from one another in a longitudinal direction (P). The optical resonator length is specified by the distance from the first reflective element (2) to the second reflective element (3) in the longitudinal direction (P), the longitudinal extent of the medium (4) arranged between the reflective elements, and the refractive index thereof. According to the invention, the optical resonator length varies in at least one lateral direction (L) running perpendicularly to the longitudinal direction (P). The invention further relates to a laser device (20) comprising such a resonator (1) and to a method for adjusting the laser device (20).

The invention relates to a laser apparatus, in particular a microchip solid-state laser, comprising an optical resonator with an optically active medium arranged between a first reflection element and a second reflection element, which are spaced apart from one another in a longitudinal direction. An optical resonator length is defined by a distance of the first reflection element from the second reflection element in the longitudinal direction and a longitudinal extent of the medium arranged therebetween and the refractive index thereof.

Optical resonators for producing laser radiation in various variants are well known from the prior art. In this respect, various technical implementations are in particular commonplace, which have in common that an optical resonance space is delimited between two reflection elements. Arranged in the optical resonance space is at least one optically active medium, which is optically pumped to generate a population inversion. An air gap can be situated between the optical medium, which is typically a doped solid and serves as an amplifier, and the reflection elements, which can be embodied in particular as dielectric mirrors. In other cases, the reflection element is applied directly to the optical medium as a dielectric coating.

Moreover, it is known to arrange additional optically active elements, such as in particular saturable absorbers, which act as passive Q-switches in the optical resonator.

The optical resonator length is defined by the effective length of the optical path that is traversed per circulation within the optical resonator. The optical resonator length is therefore determined by the distance of the two reflection elements which delimit the resonance space and the extent of the optically active media that is transmitted during the circulation and the refractive indexes thereof. The optical resonator length determines the spectral mode spacing of the longitudinal modes for which the resonance condition is met.

The spectral position of these longitudinal modes within the gain bandwidth substantially determines the degree of amplification.

In microchip solid-state lasers, the optical resonator length is short such that the spectral mode spacing approximately corresponds to the spectral bandwidth of the gain spectrum. Operation with substantially only one oscillating longitudinal mode can be achieved without the use of spectrally selective elements if the wavelength of a dominant resonator mode corresponds with good accuracy to the wavelength of the gain maximum of the gain spectrum. On the other hand, it is possible in particular in the Q-switched case, for two resonator modes to oscillate if the gain maximum is situated centrally between both modes and the two modes thus experience a similarly high gain. For adjusting the laser apparatus it is therefore necessary to control the resonator modes to orders of magnitude of a few 10 pm in order to reliably achieve single-mode behavior. Another advantage of this wavelength control is demonstrated in the re-amplification of the light produced by the microchip laser, because here the wavelength can be adapted such that the amplifier achieves its optimum efficiency.

One example to be considered is a microchip solid-state laser at 1064 nm with Nd:YVO as the optically active medium. For a typical optical resonator length of 1 mm, a mode spacing of 570 pm is obtained, comparable to the gain bandwidth of Nd:YVO, which is approximately 1 nm. In order to change the mode wavelength to which the resonance condition applies by 50 pm, the optical resonator length must be changed by 47 nm. In the prior art, this precise adjustment of the optical resonator length is attained either via a piezoelectric element or via the thermal expansion of a mechanical holder. However, both options have the disadvantage that the long-term stability of the setup cannot always be ensured and external influences, such as the temperature of the air, can easily have an influence on the mode wavelength.

Electro-optically adjustable microchip solid-state lasers are known, for example, from J. J. Zayhowski, Optical Materials, 11, 1999, pp. 255-267.

EP 0744089 B1 discloses, for example, a passively Q-switched microchip solid-state laser with a pulse length of under 1 ns, in which the amplifier medium, also referred to as laser medium or crystal, and the saturable absorber are sections of the same crystal or are otherwise inseparably connected to one another.

WO 2014/051847 A1 describes a monolithic microchip solid-state laser with an incorporated solid-state etalon for the selection of the mode wavelength. The etalon can take the form of a non-doped section of the laser crystal. The interface between etalon and laser crystal has a reflectance for the signal light that differs from zero.

U.S. Pat. No. 8,964,800 B2 describes a further microchip solid-state laser with plane-parallel resonator mirrors. Provided between laser crystal and saturable absorber is a coating with a high reflectance for the pumped light. The mode wavelength is set in one exemplary embodiment via heating of the laser crystal and possibly of the saturable absorber. The saturable absorber is separated from the laser crystal by an air gap.

It is the object of the present invention to further improve the adjustment of the optical resonator or the laser apparatus having said optical resonator.

This object is achieved by way of a laser apparatus having the characterizing features of patent claim 1.

Advantageous embodiments of the invention are the subject matter of the dependent claims.

A laser apparatus has a device for coupling the pump laser beam into an optical resonator, wherein the coupled-in pump laser beam propagates within the optical resonator parallel to a longitudinal direction. The optical resonator for the laser apparatus, in particular for a microchip solid-state laser, comprises an optically active medium that is arranged between a first reflection element and a second reflection element. The two reflection elements are spaced apart from one another in the longitudinal direction. An optical resonator length of the optical resonator is defined by a distance of the first reflection element from the second reflection element in the longitudinal direction and a longitudinal extent of the medium arranged therebetween and the refractive index thereof.

According to the invention, the optical resonator length varies in at least one lateral direction that is perpendicular to the longitudinal direction. The device and the optical resonator are movable with respect to one another such that the position of the coupled-in pump laser beam is changeable at least with respect to the lateral direction that is perpendicular to the longitudinal direction.

Consequently, the core of the invention is an arrangement of an optical resonator such that the optical resonator length thereof slightly varies in the lateral direction. Adjustment of the mode wavelength can be effected by specifically selecting a region of the optical resonator that defines a resonator length that is suitable for mode amplification. In this context, it is suggested to couple in pump light or laser light, which is provided by a pump light source or laser source, in a direction substantially parallel to the longitudinal direction. By displacing the pump laser beam in the lateral direction, the lateral position of the laser mode also changes and consequently so does the resonator length which determines the resonance condition for the modes to be amplified.

The wavelength for which the resonance condition is fulfilled, is determined by the optical resonator length. In this context of the present specification, the optical resonator length is defined by the effective length of the optical path that is traveled per circulation within the optical resonator. In this regard, the spacing of the two reflection elements is relevant in one aspect. In another aspect, the longitudinal extent of the optical media, in particular the optically active media, which are transmitted per circulation and the refractive indices thereof, are also taken into account. These can comprise, for example, an optical amplifier medium, in particular a laser crystal having at least doped sections or a saturable absorber.

The resonators under consideration here are at least approximately stable. The effective optical wavelength that defines the resonator length only slightly varies in the lateral direction.

The particular configuration of the optical resonator allows for a particularly precise adjustment of the resonator modes to be amplified and, at the same time, high thermal stability.

During the adjustment, the device for coupling in the pump laser beam is adapted to determine in particular the lateral position of the coupled-in pump laser beam with respect to the optical resonator. Since the optical resonator has subsections with different resonator lengths which can be specifically activated by way of displacing the coupled-in pump laser beam in the lateral direction, a particularly precise and robust adjustment is made possible. The resonator length varies only slightly in the lateral direction, that is to say the relative displacement of pump laser beam and optical resonator in the lateral direction is typically greater than the path length difference of the optical resonator length to be set by orders of magnitude, the latter being, in particular in microchip solid-state lasers, only about a few nanometers. This allows for a particularly exact specification of the desired resonator length.

One possibility for implementing a resonator length that varies in the lateral direction is by way of a slight tilting of the reflection elements, in particular of the resonator mirrors. The tilting of the reflection elements or of the resonator mirrors should be selected to be so small that the laser mode and the pump volume at least partially overlap such that the laser mode can experience amplification. The overlap between laser mode and pump volume is preferably 30% or more. The pump volume is defined substantially by the spatial extent of a pump laser beam that has been coupled into the resonator.

In the case of substantially planar reflection elements or resonator mirrors which are tilted with respect to one another, it would initially be expected that the resonator that is formed does not meet the stability criteria. However, it has been shown that this effect can be compensated by the thermal lens which arises during the operation of the laser apparatus and which is caused in a manner well-known by laser radiation of the coupled-in pump laser beam which is absorbed in the optical medium. This effect causes a deflection of the laser mode circulating within the resonator in dependence on their lateral position such that the laser mode is guided after one circulation substantially back to the trajectory which was previously already traversed. If the variation of the resonator length or the tilting of the resonator mirrors is sufficiently small, an overlap between pump volume and circulating laser mode which is sufficiently large for amplification continues to be provided.

Due to the slight tilting of the resonator mirrors, the slight length change in the resonator length in the propagation direction that is required for the adjustment can be converted to a greater change in a transverse, or lateral direction. For example, if the tilt is 0.5 mrad, a change in the resonator length by 47 nm corresponds to a lateral displacement of approximately 94 μm. This greater displacement transversely to the beam direction can be adjusted and stabilized permanently much more easily than the direct adjustment of the resonator mirrors in the propagation or beam direction, which in that case needs to be precise to a few nanometres.

The tilt of the resonator mirrors with respect to one another is, for example, 0.1 to 5 mrad, preferably 0.1 to 1 mrad, with particular preference 0.2 to 0.5 mrad.

For example, the entire optical resonator can be displaced here with respect to a spatially fixed pump laser beam, or the pump laser beam can be displaced with respect to a spatially fixed optical resonator.

In other exemplary embodiments, the slight lateral variation in the resonator length is implemented by way of the optical media arranged within the resonator. The extent of the optical media in the propagation direction differs here for different lateral positions such that the optical path traversed by the pump laser beam varies slightly. An adjustment can also be effected in this case in a particularly advantageous manner by way of the lateral position of the pump laser beam being changed until the desired resonator mode or the desired resonator modes are amplified.

The first reflection element and the second reflection element preferably take the form of mirrors, the substantially planar mirror surfaces of which are aligned such that they are tilted with respect to one another in deviation from a plane-parallel arrangement.

With particular preference, the first reflection element and the second reflection element are arranged at an angle with respect to one another that is so small that an at least approximately stable resonator is formed. This embodiment consequently substantially relates to a Fabry-Perot resonator, because the deviation from the plane-parallel alignment is so small that no relevant impairment of the stability criteria occurs.

In a further development of the invention, provision is made for the first and/or second reflection element to have at least a section with a curvature for forming a stable resonator. A slight curvature effects a change in the diameter of a mode volume that is defined by the laser mode circulating within the resonator. The curvature of the reflection element or of the reflection elements is preferably selected such that the diameter of the mode volume is optimally adapted to the diameter of the pump volume.

In a further exemplary embodiment, the optical medium comprises a laser crystal having substantially planar front sides that are facing the first reflection element and the second reflection element, wherein the front sides extend toward one another in an arrangement that deviates from a plane-parallel arrangement. Here, the variation in the resonator length is consequently not prescribed by the arrangement of the reflection elements, but by the longitudinal extent of the region of the laser crystal which is traversed during the circulation. In one possible exemplary embodiment, the laser crystal is substantially wedge-shaped, with the result that an optical path of varying length must be traversed depending on the lateral position of the pump laser beam.

For reasons of simplified adjustment, what has proven advantageous is to connect the optical medium fixedly to the first and/or the second reflection element. The optical medium is fixedly, in particular inseparably connected to one of the reflection elements, by way of diffusion bonding, spin-on glass or other joining techniques which are known in the art, to reduce the number of the degrees of freedom to be calibrated. In addition, air gaps within the resonator, which can cause stability problems due to the thermal expansion that occurs during operation are avoided to at least a partial extent.

In accordance with a preferred exemplary embodiment, the first reflection element or the second reflection element is a saturable absorber. The saturable absorber acts as a passive switching element, in particular as a highly reflective rear-side mirror or as a passive output coupling element which significantly changes its transmission behavior for the laser radiation which is amplified within the resonator if the energy density within the resonator exceeds a predetermined threshold value. Thus, the optical resonator is configured as a passively switched laser resonator capable of producing laser pulses with high intensity and short pulse durations.

With respect to the method, the object mentioned previously is achieved by way of a method for adjusting a laser apparatus having the further features of patent claim 8.

The pump laser beam is coupled into the optical resonator such that it propagates within the optical resonator substantially parallel to the longitudinal direction. In accordance with the invention, the position of the pump laser beam is changed at least with respect to the lateral direction extending perpendicular to the longitudinal direction in order to select a region of the optical resonator with a specifiable optical resonator length. The desired resonator length is selected in particular with respect to the resonator modes to be amplified, and it is thus suggested to activate a specific partial region of the optical resonator such that the wavelength or wavelengths of one or more specified resonator modes is/are within the gain spectrum of the optical medium.

Possible exemplary embodiments of the invention will be explained in more detail below with reference to the drawings. In the drawing:

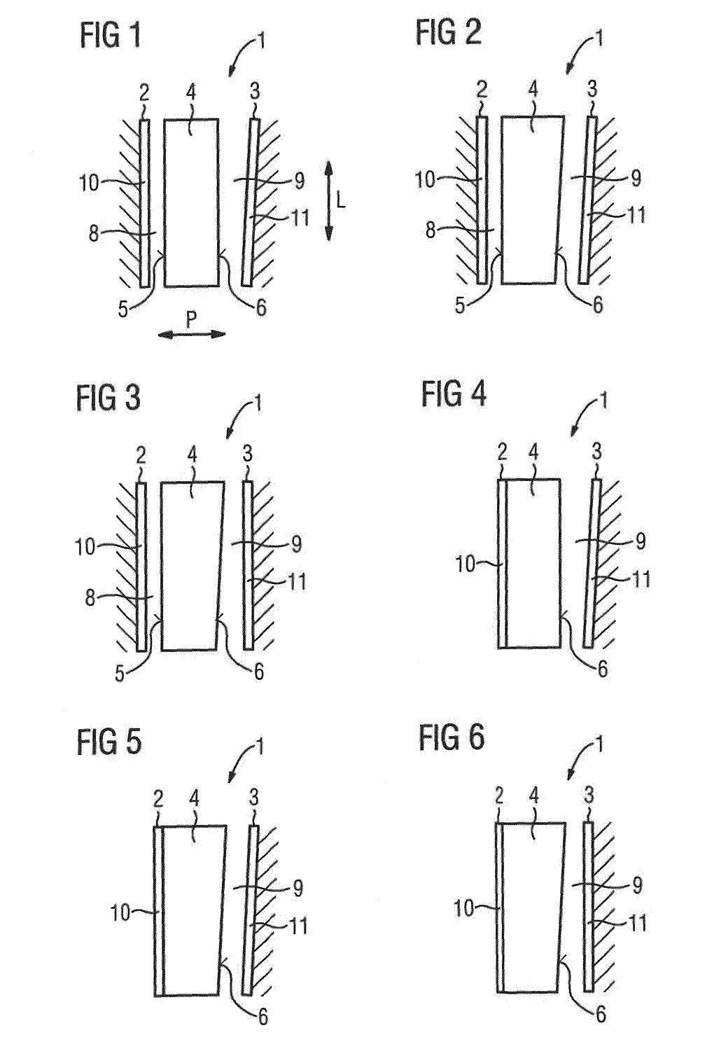

FIG. 1 shows an optical resonator in accordance with a first exemplary embodiment of the invention in a schematic sectional illustration;

FIG. 2 shows an optical resonator in accordance with a second exemplary embodiment;

FIG. 3 shows an optical resonator in accordance with a third exemplary embodiment;

FIG. 4 shows an optical resonator in accordance with a fourth exemplary embodiment;

FIG. 5 shows an optical resonator in accordance with a fifth exemplary embodiment;

FIG. 6 shows an optical resonator in accordance with a sixth exemplary embodiment;

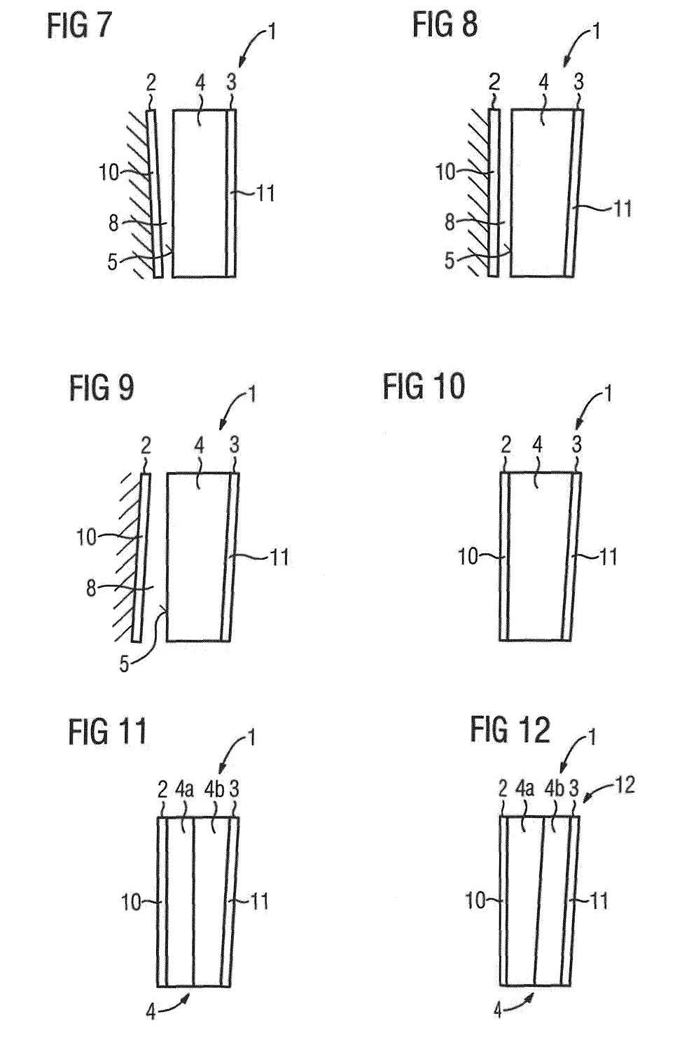

FIG. 7 shows an optical resonator in accordance with a seventh exemplary embodiment;

FIG. 8 shows an optical resonator in accordance with an eighth exemplary embodiment;

FIG. 9 shows an optical resonator in accordance with a ninth exemplary embodiment;

FIG. 10 shows an optical resonator in accordance with a tenth exemplary embodiment;

FIG. 11 shows an optical resonator in accordance with an eleventh exemplary embodiment;

FIG. 12 shows an optical resonator in accordance with a twelfth exemplary embodiment;

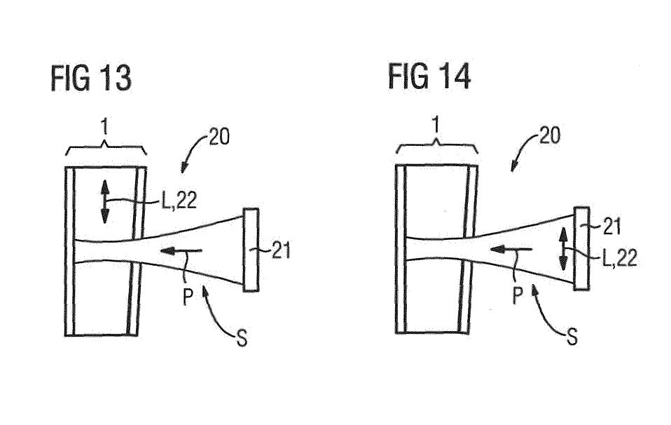

FIG. 13 schematically shows a laser apparatus having an optical resonator, shown in FIGS. 1 to 8, and a device for coupling in a pump laser beam;

FIG. 14 schematically shows a further laser apparatus with one of the optical resonators shown in FIGS. 1 to 12.

Mutually corresponding parts are provided in all figures with the same reference signs.

FIG. 1 shows an optical resonator 1 in accordance with a first embodiment. The optical resonator 1 comprises a first reflection element 2 and a second reflection element 3. Arranged between the two reflection elements 2, 3 is an optically active medium 4. In the present case, the optically active medium 4 provided for laser amplification is a laser crystal.

The first reflection element 2 is configured as an output coupling mirror which is separated from the optical medium 4 or from the laser crystal by an air gap 8. The optical medium 4 in turn is separated from the second reflection element 3, which is configured as a rear-side mirror, by a further air gap 9. The laser crystal acting as the optical medium 4 has two front sides 5, 6 which are arranged so as to be plane-parallel with respect to one another. The first reflection element 2, configured as an output coupling mirror, and the second reflection element 3, configured as a rear-side mirror, are arranged such that they are tilted with respect to one another and consequently extend at an acute angle with respect to one another. The further air gap 9, extending between the second reflection element 3 and the front face 6 of the optical medium 4, is wedged-shaped.

In other embodiments, the air gap 8 between the optical medium 4 and the second reflection element 3 configured as a rear-side mirror is wedge-shaped, or both air gaps 8, 9 are wedge-shaped.

The optical medium 4 configured as a laser crystal can be coated to achieve a defined reflectance for the signal and/or pump light.

Either the first or the second reflection element 2, 3 has a high transmittance for the wavelength of the pump light, or of the pump laser beam. In possible alternative embodiments, either the first or the second reflection element 2, 3 is configured as a saturable absorber. The reflection elements 2, 3 of the exemplary embodiment shown in FIG. 2 are mirrors having planar mirror surfaces 10, 11, which are tilted with respect to one another. In another exemplary embodiment, the mirror surfaces 10, 11 have a slight curvature in order to adapt the mode volume used by the laser mode, which is circulating within the optical resonator, to the pump volume defined by the pump laser beam.

It is to be understood that the schematic illustration shown in FIGS. 1 to 14 in particular of the optical resonator 1 is not to scale. In particular, the tilting of the reflection elements 2, 3 with respect to one another, or the wedge-shaped configuration of the optically active medium 4 and/or the air gaps 8, 9 situated therebetween, are illustrated in strongly exaggerated fashion to illustrate the variation of the resonator length for different positions of the pump laser beam with respect to a lateral direction L. In the actual implementation, in particular in microchip solid-state lasers, the resonator length which is traversed by the pump laser beam per circulation varies only slightly, for example by about 10 nm to 100 nm. The pump laser beam propagates within the optical resonator 1 substantially in the longitudinal direction P. The tilting of the two reflection elements 2, 3 has no noticeable influence on the stability of the optical resonator 1 that is formed.

FIGS. 2 to 10 show further exemplary embodiments of the optical resonator 1. These exemplary embodiments substantially differ in terms of the specific arrangement of the reflection elements 2, 3 with respect to one another or in terms of the specific geometric embodiment of the optically active medium 4, i.e. the laser crystal. In accordance with various exemplary embodiments, the optical medium 4 is wedge-shaped, i.e. the two front faces 5, 6 of the optical medium 4 do not extend in a plane-parallel arrangement with respect to one another, but at an angle with respect to one another. Such embodiments also define a resonator length which varies for different lateral positions.

FIG. 2 shows an optical resonator 1 in accordance with a second embodiment. The first reflection element 2, which is configured as an output coupling mirror, is separated from the optically active medium 4 by the air gap 8. The optically active medium 4 in turn is separated from the second reflection element 3, is configured as a rear-side mirror, by the air gap 9. The optically active medium 4 is a wedge-shaped laser crystal.

The mirror surface 10 of the first reflection element 2, or of the output coupling mirror, extends plane-parallel with respect to the opposite front side 5 of the optical medium 4.

The second reflection element 3 configured as the rear-side mirror, extends plane-parallel to the opposite front side 6 of the optical medium 4. Alternatively, the front side 6, as is illustrated in the exemplary embodiment in FIG. 3, can be arranged at an angle with respect to the second reflection element 3. Output coupling mirror and rear-side mirror can extend plane-parallel with respect to one another (FIG. 3) or, as is illustrated in FIG. 2, extend at an angle with respect to one another.

In a fourth embodiment shown in FIG. 4, the first reflection element 2 configured as the output coupling mirror, is connected inseparably to the optical medium 4. The inseparable connection between the optical medium 4 and the first reflection element 2 can be realized, for example, by a dielectric coating on the optical medium 4 configured as the laser crystal, or by bonding or adhesively bonding an output coupling mirror onto the laser crystal.

The optical medium 4, or the laser crystal, is separated from the second reflection element 3, which serves as a rear-side mirror, by the air gap 9. In this case, the laser crystal is plane-parallel, and the air gap 9 is wedge-shaped. The side of the optically active medium 4 that is opposite the first reflection element 2 can be coated to achieve a defined reflectance for the signal and/or pumped light.

The first reflection element 2 of the fifth exemplary embodiment shown in FIG. 5 is also connected inseparably to the optical medium 4. In contrast to the example shown in FIG. 4, the second reflection element 3, or the planar mirror surface 11 thereof, is parallel with respect to the opposite front face 6 of the optical medium 4. In the sixth exemplary embodiment of FIG. 6, the mirror surface 11 of the second reflection element 3 extends at an acute angle with respect to the front side 6 of the optical medium 4. In the fifth and in the sixth exemplary embodiments, the optical medium 4 is wedge-shaped, and the front sides thereof extend at an angle with respect to one another.

In a seventh embodiment, which is illustrated schematically in FIG. 7, the first reflection element 2, which serves as an output coupling mirror, is spaced apart from the optical medium 4 by an air gap 8. The optical medium 4 is plane-parallel, and the air gap 8 is wedge-shaped. The second reflection element 3 configured as rear-side mirror is connected inseparably to the optical medium 4. This can be implemented e.g. by a dielectric coating on the laser crystal or by bonding or adhesive bonding of the rear-side mirror to the laser crystal. The front side 5 of the laser crystal can be coated to achieve a defined reflectance for the signal and/or pumped light.

In the eighth exemplary embodiment shown in FIG. 8, the first reflection element 2 configured as the output coupling mirror, is separated from the optical medium 4 by the air gap 8. The optical medium 4 is wedge-shaped, and the air gap is, as shown in FIG. 8, plane-parallel or, alternatively, as shown in FIG. 9, wedge-shaped. In the eighth and ninth exemplary embodiments of FIGS. 8 and 9, the second reflection element 3 configured as the rear side mirror, is connected inseparably to the optical medium 4. This can be implemented e.g. by a dielectric coating on the crystal or by bonding or adhesive bonding of a rear-side mirror onto the crystal. The front side 5 of the laser crystal can be coated to achieve a defined reflectance for the signal and/or pumped light. Either the output coupling mirror or the rear-side mirror is adapted to exhibit high transmittance for the pumped light. Either the output coupling mirror or the rear-side mirror may be configured as a saturable absorber. The resonator mirrors are preferably planar, but can also have a curvature which is so small that a stable resonator 1 is formed.

In a tenth exemplary embodiment, which is schematically illustrated in FIG. 10, the first reflection element 2, which serves as an output coupling mirror, and the second reflection element 3, which serves as a rear-side mirror, are connected inseparably to the optical medium 4 configured as the laser crystal. The first and second reflection elements 2, 3 are implemented by dielectric coating on the optical medium 4. The laser crystal acting as the optical medium 4 also has a wedge-shaped form in the tenth exemplary embodiment. In an alternative exemplary embodiment, the first and second reflection elements 2, 3 are connected to the optical medium 4 by way of bonding or adhesive bonding.

In a further aspect of the invention, the optical resonator 1 in a includes additional discrete optical elements, such as active Q-switches or saturable absorbers 12. Such a modification of the optical resonator 1 is provided independently of the specific configuration thereof, in particular all the geometries shown in FIGS. 1 to 10 are possible. The reflection elements 2, 3 in each of the examples shown may be adapted as saturable absorbers.

FIGS. 11 and 12 schematically illustrate the eleventh and the twelfth exemplary embodiments of the invention. The optical medium 4 is a doped laser crystal having a plurality of sections 4a, 4b, which differ in terms of the type of doping and/or their doping concentration. The first section 4a serves as an amplifier medium which generates the optical gain. The second section 4b is a saturable absorber 12. Both sections 4a, 4b are connected inseparably to one another.

In another exemplary embodiment, one of the two sections 4a, 4b is undoped. The first section 4a and the second section 4b are doped with doping atoms or ions of the same chemical element, and in an alternative embodiment with doping atoms or ions of different chemical elements.

In a possible exemplary embodiment, which is not illustrated in more detail, the optical medium 4 additionally has an undoped section which serves for improving the heat dissipation from the laser-active first section 4a. Additionally, coatings may be applied between the different crystal sections to attain a defined reflectance for the signal and/or pumped light.

As shown by way of example in FIGS. 11 and 12, the sections 4a, 4b may be cube-shaped or wedge-shaped. In particular, the laser-active first section 4a can have, as is shown in FIG. 11, two plane-parallel opposite front faces, and the saturable absorber 12 can be wedge-shaped. In the twelfth exemplary embodiment (FIG. 12), the laser-active first section 4a is wedge-shaped and the saturable absorber 12 is cube-shaped with plane-parallel opposite front faces.

FIGS. 13 and 14 schematically illustrate a laser apparatus 20 having one of the optical resonators 1 described above. FIGS. 13 and 14 show merely by way of example the specific exemplary embodiment of FIG. 10, wherein it is to be understood that all other optical resonators 1 as described herein before can be used analogously in the laser apparatus 20.

The laser apparatus 20 has the optical resonator 1 which defines an optical resonator length which varies in dependence on the lateral positioning of a pump laser beam S that has been coupled in. The pump laser beam S can be coupled into the optical resonator 1 using the device 21, wherein the positioning of the pump laser beam S can be specified in particular with respect to the lateral direction L. In other words, the device 21 and the optical resonator 1 are movable relative to one another such that the region that is traversed by the pump laser beam S during circulation in the resonance space can specifically be selected. The relative positioning of the device 21 and of the optical resonator 1 thus defines the effective resonator length and the spectral mode spacing of the resonator modes to be amplified.

In FIG. 13, the adjustment of the laser apparatus 20 is effected by displacing the optical resonator 1 in the lateral direction L with respect to a spatially fixed device 21, which provides the pump laser beam S. This is indicated in FIG. 13 by way of the double-headed arrow 22.

In FIG. 14, the laser apparatus 20 is adjusted by moving the device 21 with respect to the spatially fixed optical resonator 1. A region of the optical resonator 1 having a suitable resonator length is also selected here by adjusting the position of the pump laser beam S with respect to the lateral direction L.

The invention has been described above with reference to preferred exemplary embodiments. However, it is to be understood that the invention is not limited to the specific configuration of the exemplary embodiments shown, it is understood that the competent person skilled in the art can derive variations on the basis of the description without departing from the essential concept of the invention. In particular, independently of the specific coniguration of the optical resonator 1 shown in FIGS. 1 to 12, at least one of the two reflection elements 2, 3 may be configured as a saturable absorber 12. Any front faces 5, 6 of the optical medium 4 may be provided with coatings to adapt the reflectance for the pump and/or for the signal light in a way suitable for the laser amplification. Furthermore, the schematically illustrated resonators 1 may have a slight curvature such that they comply with the stability criteria.

### LIST OF REFERENCE SIGNS

1 optical resonator
2 first reflection element
3 second reflection element
4 optical medium
5 front face
6 front face
8 air gap
9 air gap
10 mirror surface
11 mirror surface
12 saturable absorber
20 laser apparatus
P longitudinal direction
L lateral direction
S pump laser beam

1. A laser apparatus comprising
an optical resonator (1) with an optical medium (4) which is arranged between a first and a second reflection element (2, 3), wherein the first and the second reflection element (2,3) are spaced apart from one another in a longitudinal direction (P), wherein an optical resonator length is defined by a distance of the first reflection element (2) from the second reflection element (3) in the longitudinal direction (P) and a longitudinal extent of the medium (4) arranged therebetween and the refractive index thereof, and
a device (21) for coupling a pump laser beam (S) into the optical resonator (1), wherein a coupled-in pump laser beam (S) propagates within the optical resonator (1) parallel to the longitudinal direction (P), wherein the optical resonator length of the optical resonator (1) varies in at least one lateral direction (L) that is perpendicular to the longitudinal direction (P) and the device (21) and the optical resonator (1) are movable with respect to one another such that the position of the coupled-in pump laser beam (S) is changeable at least with respect to the lateral direction (L) that is perpendicular to the longitudinal direction (P).

2. The laser apparatus according to claim 1, wherein the first reflection element and the second reflection element (2, 3) are configured as mirrors having substantially planar mirror surfaces (10, 11) which are tilted with respect to one another in deviation from a plane-parallel arrangement.

3. The laser apparatus according to claim 2, wherein the first reflection element and the second reflection element (2, 3) are arranged at a small angle with respect to one another such that an at least approximately stable resonator is formed.

4. The laser apparatus according to claim 1, wherein the first and/or second reflection element (2, 3) at least include sections sectionally having a curvature for forming a stable resonator.

5. The laser apparatus according to claim 1, wherein the optical medium (4) comprises a laser crystal, having substantially planar front sides (5, 6) that are facing the first reflection element and the second reflection element (2, 3), wherein the substantially front sides (5, 6) extend toward one another in an arrangement that deviates from a plane-parallel arrangement.

6. The laser apparatus according claim 1, wherein the optical medium (4) is fixedly connected to the first and/or the second reflection element (2, 3).

7. The laser apparatus according to claim 1, wherein the first or second reflection element (2, 3) is a saturable absorber (12).

8. A method for adjusting a laser apparatus (20) according to claim 1, wherein a pump laser beam (S) is coupled into the optical resonator (1) such that it propagates within the optical resonator (1) substantially parallel to the longitudinal direction (P), wherein the position of the pump laser beam (S) is changed at least with respect to the lateral direction (L) that is perpendicular to the longitudinal direction (P) to select a region of the optical resonator (1) with a specifiable optical resonator length.
